(19) United States
(12) Patent Application Publication
(10) Pub. No.: US 2008/0075576 A1
(43) Pub. Date: Mar. 27, 2008

(54) Method and device for putting rows in intermediate storage and making them available

(76) Inventors: Thomas SALM, Aachen (DE); Hans-Josef DRIESSEN, Eschweiler (DE)

Correspondence Address: COLLARD & ROE, P.C., 1077 NORTHERN BOULEVARD, ROSLYN, NY, 11576, US

(21) Appl. No.: 11/903,674

(22) Filed: Sep. 24, 2007

(30) Foreign Application Priority Data
Sep. 22, 2006 (DE) 10 2006 045 277.1

(51) Int. Cl. B65G 57/28; B65G 61/00

(52) U.S. Cl. 414/789.2; 414/801

(57) ABSTRACT

A method and a device for putting flat, stacked objects, particularly envelopes, packaging bags, and the like, in intermediate storage and making them available. The flat objects coming out of a production machine are set down onto a stacking surface with one of their edges, and subsequently transported to a transfer location by a device for forming and making available defined rows. From there, the rows are pushed to a storage location or the issuance location, using a transport device that is driven independently of the machine cycle.

### BACKGROUND OF THE INVENTION

1. Field of the Invention

The present invention relates to a method and a device for putting rows in intermediate storage and making them available, which rows are separated from flat objects supplied in stacks, such as envelopes, packaging bags, paperboard cutouts, and the like.

2. The Prior Art

Machines for the production of flat objects, such as envelopes, for example, generally form a stack at the exit of the machine, which is formed by the products, which arrive continuously. Various methods are known for forming rows from this continuously arriving stack, which are subsequently packaged into cartons, automatically or by hand.

'A method and a device for forming, holding, separating, and transporting stacks are known from German Patent No. DE 41 17 434 A1, whereby a partial stack/row is formed from the stacks formed at the exit of a production machine, by means of several stack supports, which stack/row is pushed into a collection region.

The method steps and the structure of the device are tied in with the machine cycle. This means that the operator or a take-over device must remove the row within a time window, otherwise the production machine must stop, and this significantly reduces the degree of production effectiveness.

Another known device brings about that one envelope is jogged out after a certain number of envelopes, which then form a row. In this connection, the leading end of the stack is held by means of a displaceable stack support. The stack thus consists of a started row and of one or more finished rows, which are separated by means of envelopes that have been jogged out, for example. The length of the deposit surface thus determines the length of the stack, and thus the size of the storage area. Since no defined deposit location is present here, the rows must be removed from the stack by hand, pressed together to the inside carton dimension, and pushed into the carton. The removal location, and therefore the working position of the operating personnel, migrates as a function of the length of the stack, and this makes the work more difficult for the operator.

A device for packaging flat objects is known from EP 0 981 480 B1, which separates partial stacks from a stack that is formed by products that arrive continuously, turns the partial stacks about an axle, and slants every other partial stack about a second axle, so that a row formed of partial stacks is formed, whereby adjacent partial stacks have an edge orientation in the opposite direction. The finished rows are then made available for packaging as a function of the machine cycle, so that this device is also dependent on the machine cycle.

### SUMMARY OF THE INVENTION

It is therefore an object of the present invention to create a method and a device, respectively, for putting rows of flat, stacked objects, particularly envelopes, packaging bags, or the like, in intermediate storage and making them available, which method or device allows removal of finished rows at a defined issuance location, independent of the machine cycle.

This object is accomplished by means of a method for putting rows of flat, stacked objects, particularly of envelopes, packaging bags, and the like, in intermediate storage and making them available. The rows are made available at a transfer location (A) in cycled manner, in the correct number, and with the desired orientation of their edges, and from there are transported directly or by way of at least one storage location (C) to an issuance location (B). A row is moved from the transfer location (A) or from a storage location (C), independent of the machine cycle, by at least one row width to or in the direction of the issuance location, as soon as there is no longer any row at the issuance location and/or a new row stands available at the transfer location. If there is a spacing of more than one row width between the transfer location and the issuance location, the row or rows situated in front of it, viewed in the transport direction, is/are moved farther using the row last finished.

Accordingly, the invention provides that finished rows that are made available at the transfer location in the machine cycle are pushed onto the issuance location independent of the machine cycle.

In addition, one or more storage locations are provided between the transfer location and the issuance location, in order to even further uncouple removal of the rows at the issuance location from the machine cycle.

A row consists of a certain number of flat, stacked objects, envelopes, for example, as they are usually made available by an envelope production machine having a row formation device and/or partial stack formation device. In this connection, a row can consist of several partial stacks, which have different edge orientations and/or are separated by means of separator paperboards.

According to the invention, removal of finished rows takes place at a defined issuance location, at which the rows can be removed independent of the machine cycle. In this connection, removal can take place by hand or by machine. For better removal, a tilting device can additionally be provided at the issuance location, which tilts the row in such a manner that the operator merely has to tilt the empty packaging carton by 90°, for example, push it over the rows, and then put the filled carton back down in the starting position.

Transport of the rows from the transfer location to the issuance location or to a storage location preferably takes place by means of a pushing device that pushes the rows crosswise to the stack formation direction. To guide and hold the stack, guides are provided in the region of the storage locations and the issuance location. In the region of the transfer location, the rows are held and guided by the holding supports of the longitudinal pushing device that transports the rows from the collection region to the transfer location, or by means of an additional movable support/guide device.

The rows are generally compressed to the planned inside carton dimension and/or the air is removed from them at the collection location, but they can also be compressed and/or the air can be removed from them by means of correspondingly disposed guides on the stretch from the transfer location to the issuance location.

Alternatively to the positioning of the issuance location and storage locations in the crosswise direction, positioning in the longitudinal direction is also possible, but then additional devices are required in order to obtain the same functionality.

The storage effect already occurs in that a finished row is pushed to the issuance location independent of the machine cycle, as soon as a sensor of the control of the pushing device reports that there is no longer a row present at the issuance location. Thus, is it possible to remove all of the finished rows within a relatively short period of time, and to utilize the time until the transfer location and the issuance location are filled again for other activities, such as preparing new packaging cartons, putting filled cartons on pallets, or also operating a second production line.

To increase the storage effect, additional storage locations can be provided between transfer location and issuance location.

If one or more storage locations are present, a finished row is pushed directly onto the issuance location if the storage area is empty and the issuance location is empty. Subsequently, the storage area is filled from the issuance location, whereby the sensors of the control of the pushing device report what storage locations are occupied, so that the pushing device pushes the rows far enough into the storage area so that no storage area gaps occur.

If an operator now removes a stack, the sensor reports this to the control of the pushing device, and this now has two possibilities for filling the issuance location with a row again. If all of the storage locations are empty, the pushing device waits until a row has been made available at the transfer location, and then pushes this directly to the issuance location. If one or more row(s) are available in the storage area, the row farthest forward is pushed to the issuance location by the pushing device, directly or by means of the rows that lie in front of it.

Thus, the operator can not only package the finished rows into packaging cartons in particularly advantageous manner, in accordance with his working speed, but furthermore can utilize the time that is required to fill all of the storage locations again to pursue other activities, such as operating another machine.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a sketch of the storage device, in a top view;

FIG. 2 shows a side view of the storage device with pushing device;

FIG. 3 shows a side view of the storage device with pushing device and tilting device; and

FIG. 4 shows a top view of two parallel production machines that are operated by one operator.

### DETAILED DESCRIPTION OF THE PREFERRED EMBODIMENT

In the following, embodiments of the present invention will be described as examples, in connection with the production of envelopes.

However, other application cases are possible within the framework of the present invention, such as, for example, in connection with the production of bottle labels or folded box cutouts for medication boxes.

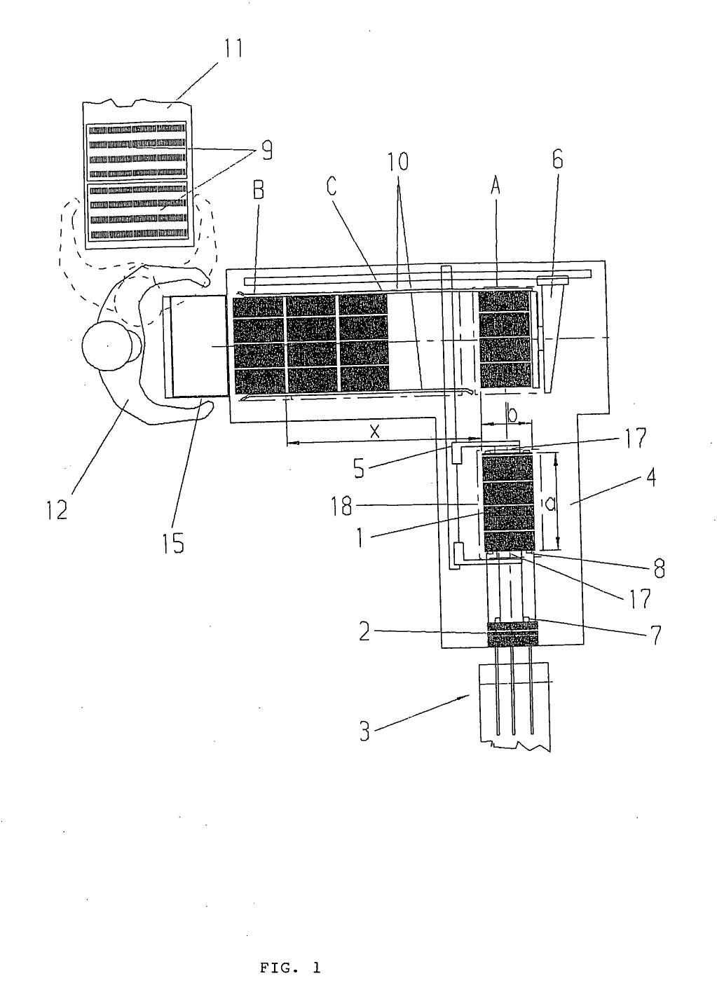

FIG. 1 shows a schematic representation of a top view of the storage device with the defined issuance point at the issuance location A. All of the devices shown in FIG. 1-4 are fundamentally known machine parts.

The products, which arrive continuously, are set down on the stacking surface 4 at the exit of the production machine 3, with one edge. A device such as the one known from German Patent No. DE 41 17 434 A1 then makes a row 1 available at the collection region 18. From there, this row is pushed to the transfer location A by means of a longitudinal pushing device 5, and held by means of the holding supports 17 or another movable holding device long enough until the pushing device 6 has pushed the row 1 sufficiently far into the guide 10 that the row 1 is held by the latter.

The pushing device 6 then pushes the row 1 farther up to the issuance location B, or also to the next closest free storage location C, seen from the issuance location B.

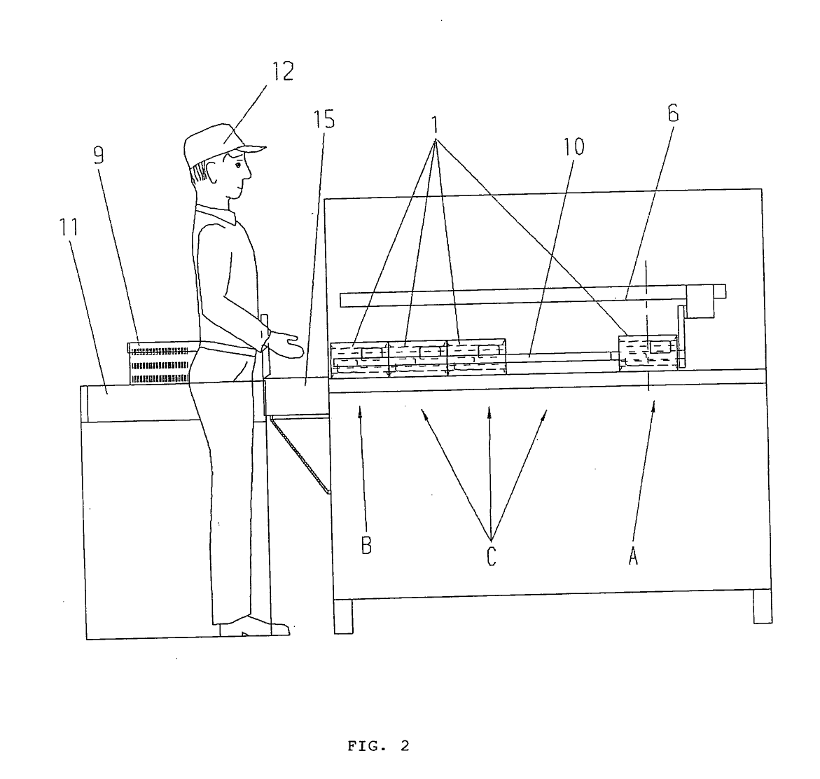

The particularly advantageous working sequence for the operator can be seen in FIGS. 1 and 2, among other things.

The rows 1 made available at the issuance location B are picked up by the operator 12 and pushed into the packaging carton that has been made available, which is subsequently set down onto a conveyor belt 11 for further transport. In order for the operator 12 to be able to pick up the rows 1 easily and securely, it is necessary for the edge orientation to be selected in such a manner that when the row 1 is picked up, it does not fall apart, as would be the case, for example, if all of the closure flaps of envelopes point downward, and therefore the row 1 is wider at the bottom than at the top. The edge orientation can be optimized by means of a turning device, as described in European Patent No. EP 0981 480 B1, for example, between the exit of the production machine 3 and the transfer location A.

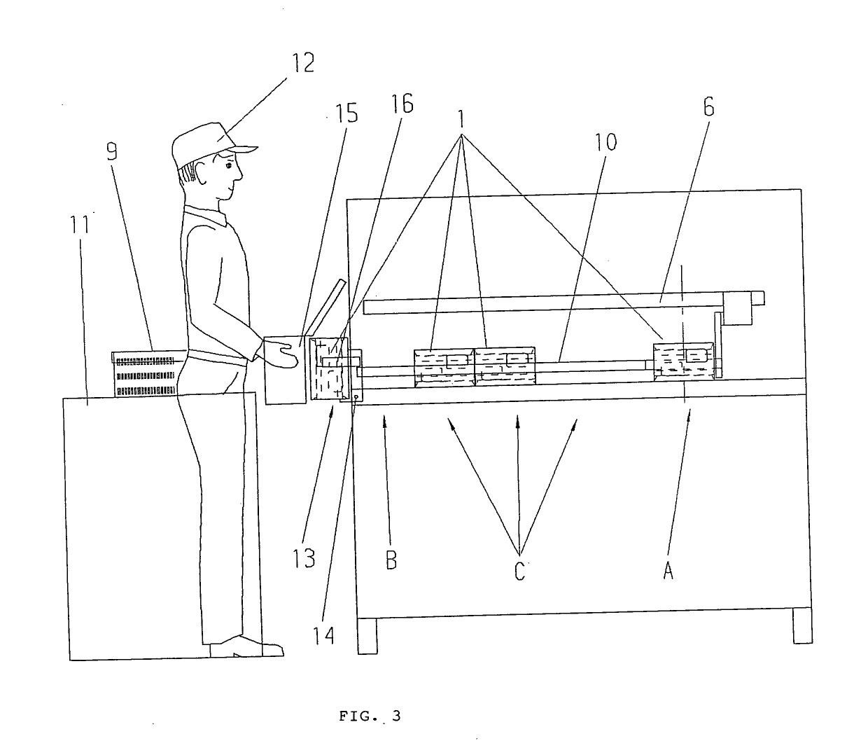

Another embodiment is shown in FIG. 3. Here, the rows 1 are made available by means of a tilting device, which picks up a row 1 from the issuance location B and tilts it about the axle (14), preferably by 90°. As a result, the operator no longer has to pick up the row 1, but rather can simply push the packaging carton over the row 1. Thus, all of the rows 1 with non-turned envelopes can be securely packaged.

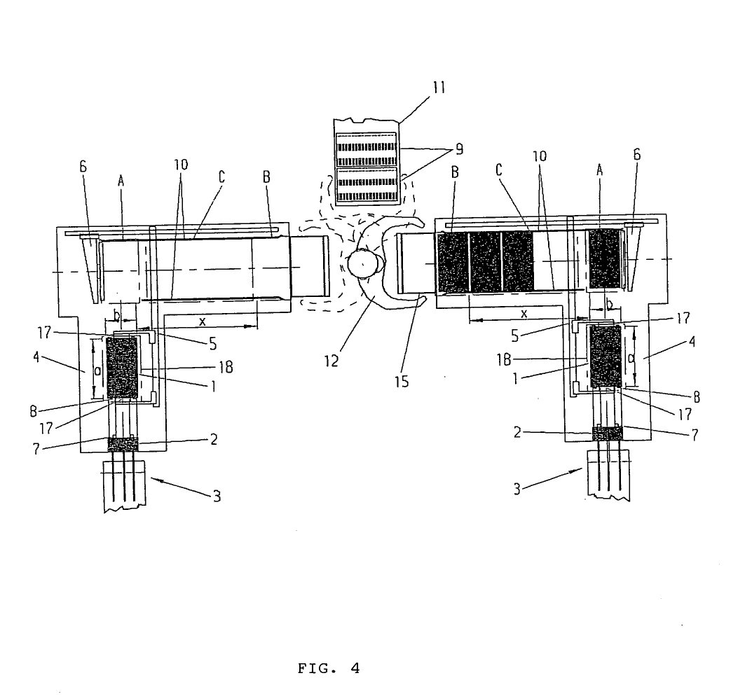

FIG. 4 shows two parallel production machines followed by a device according to the invention, in each instance, in a mirror-image embodiment, which is then operated by one operator. In the case of this arrangement, only one conveyor belt 11 for transporting away the packaged rows 9 is required for two production machines, for example.

However, in place of the operator, a robot can also be used, which can perform other activities during the time the storage area is filled, such as preparing a new pallet, for example.

From the exemplary embodiments described above, the following advantages are obtained, in particular, as compared with the state of the art:

The operator or a supplemental automation component no longer has to work within the cycle.

Ergonomic workplace design with a reduction in work stress.

Avoidance of unnecessary machine stops, therefore greater efficiency (less scrap).

The operator has time for other activities.

Accordingly, while only a few embodiments of the present invention have been shown and described, it is obvious that many changes and modifications may be made thereunto without departing from the spirit and scope of the invention.

### REFERENCE SYMBOL LIST

1 row
2 stack
3 exit of production machine
4 stacking surface/deposit surface
5 longitudinal pushing device
6 pushing device
7 holding finger
8 separating finger
9 packaged row
10 guide
11 conveyor belt
12 operator
13 tilting device
14 tilting axle
15 packaging carton
16 side guide
17 holding support
18 collection region
A transfer location
B issuance location
C storage location
a, b row dimensions
x spacing

What is claimed is:

1. A method for putting rows of flat, stacked objects in intermediate storage and making them available, comprising the following steps:
making said rows available at a transfer location in a cycled manner, in a correct number, and with a desired orientation of their edges;
transporting the rows in the transfer location directly or by way of at least one storage location to an issuance location;
wherein a row is moved from the transfer location or from a storage location, independent of a machine cycle, by at least one row width in a direction of the issuance location, as soon as there is no longer any row at the issuance location or a new row stands available at the transfer location, and
wherein if there is a spacing of more than one row width between the transfer location and the issuance location, the row or rows situated in front of the spacing, viewed in a transport direction, is/are moved farther using the row last finished.

2. A method according to claim 1, wherein the issuance location or the storage locations lie crosswise to a direction of stack formation.

3. A method according to claim 1, wherein a new row on the transfer location is moved first to an empty storage location.

4. A method according to claim 1, wherein each row is tilted at the issuance location about an axle that runs parallel to the row formation.

5. A method according to claim 1, wherein a row is removed from the issuance location while a new row is moved in a direction of the issuance location or storage location.

6. A device for putting flat, stacked objects in intermediate storage and making them available, comprising;
a stacking surface for receiving edges of the flat objects coming out of a production machine, said stacking surface consisting of a device for forming and making available defined rows on a transfer location;
a transport device for transporting the rows to an issuance location, said transport device having a drive assigned to it, said drive moving the transport device independent of the machine cycle.

7. A device according to claim 6, wherein the transport device is a pushing device that pushes the rows crosswise to a stack formation direction.

8. A device according to claim 7, further comprising a tilting device disposed at the issuance location, said tilting device adapted to be tilted about an axle that runs parallel to the row formation.

9. A device according to claim 8, wherein the tilting device is driven independently of the machine cycle and of the pushing device.

10. A device according to claim 7, wherein the pushing device can move to any position between the transfer location and issuance location.
